(19) United States
(12) Patent Application Publication
(10) Pub. No.: US 2007/0116032 A1
(43) Pub. Date: May 24, 2007

(54) Open cable broadcast processing apparatus and control method thereof, and cable card software upgrading method for open cable system

(75) Inventors: Do-young Kim, Suwon-si (KR); Eun-kyung Kang, Seoul (KR); Kyoung-mi Jin, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/593,019

(22) Filed: Nov. 6, 2006

(30) Foreign Application Priority Data
Nov. 9, 2005 (KR) 10-2005-0107210

(51) Int. Cl. H04L 12/413

(52) U.S. Cl. 370/445

(57) ABSTRACT

An open cable broadcast processing apparatus and control methods are provided. The broadcast processing apparatus includes a tuner to tune a cable signal supplied from a delivery system, an interface which is connected with a cable card descrambling the cable signal supplied through the tuner; and a controller which controls the tuner to change a reception channel based on received channel information when the channel information is received from the cable card through the interface to upgrade software, and controls not to change an operation corresponding to an operational change command when the operational change command is input to request an operational change. Thus, a channel supplying software information is prevented from being changed while upgrading software of a cable card and the upgrading operation is completed without interruption.

### CROSS-REFERENCE TO RELATED APPLICATIONS

This application claims priority from Korean Patent Application No. 10-2005-0107210, filed on Nov. 9, 2005, in the Korean Intellectual Property Office, the entire disclosure of which is incorporated herein by reference.

### BACKGROUND OF THE INVENTION

1. Field of the Invention

Apparatuses and methods consistent with the present invention relate to open cable broadcast processing, and more particularly, to an open cable broadcast processing apparatus which is capable of upgrading software of a cable card, and a control method thereof, and a cable card software upgrading method for an open cable system.

2. Description of the Related Art

A digital cable set top box which is being currently supplied for commercial service is connected with a cable head end as a delivery system which supplies a digital cable signal. The digital cable set top box connected with the cable head end receives cable broadcasting programs through an in-band (IB), and transmits/receives out-of-band (OOB) data to/from the cable head end through an out-of-band among a frequency band of the supplied cable signal, thereby communicating bi-directionally with the head end.

The digital cable set top box also includes a conditional access (CA) system which descrambles cable signals supplied from the cable head end in a scrambled format.

The digital cable set top box is not open to the public. Rather, the digital cable set top box is closed in that it has preset standards and only a set top maker in association with a cable system operator (SO) produce it. Meanwhile, a new kind of business model is being pursued which sets standards, i.e., an open cable, and allows several manufacturers to manufacture and sell a digital cable set top box, to reduce the burden on cable system operators.

Such an open cable system comprises an open cable set top box which separates a security module (hereinafter, to be referred to as a cable card) having a CA system in an existing cable set top box, and a cable card. The open cable system defines a standard interface for communication between the open cable set top box and the cable card.

When the cable SO provides a subscriber with a cable card, a subscriber purchases the open cable set top box and connects the cable card therewith through the standard interface of the open cable set top box to receive various cable broadcastings. That is, the cable card descrambles a cable broadcasting program received through the IB by using the open cable set top box and outputs the descrambled cable broadcasting program back to the open cable set top. The cable card communicates with the head end through the OOB by using the open cable set top and communicates with the open cable set top box through a data channel and an extension channel after interpreting a command from the head end. Thus, commands from the head end can be executed or contents input by a user can be transmitted to the head end.

The cable card is a necessary element in the open cable system and software upgrades to the cable card are achieved by a homing function controlled by the head end.

Hereinafter, a related art software upgrading operation of the cable card will be described in brief. When a predetermined command is input from the head end for the software upgrading operation, the cable card supplies predetermined channel information to the open cable set top box to receive software for the upgrading operation from the head end. Then, the open cable set top box changes a reception channel according to the channel information supplied by the cable card. Software information which is supplied by the head end through the changed channel is then supplied to the cable card through the open cable set top box. The cable card upgrades the software by using the received software information. When the software upgrading operation is completed, the homing function is complete.

However, the conventional open cable system changes its operation when a predetermined operational change command is input to change the channel supplying the software information while upgrading the software of the cable card, thereby failing to upgrade the software normally. When the channel is abruptly changed during the software upgrading operation of the cable card, the software upgrading operation thereof fails to and undergo a difficulty to operate normally.

### SUMMARY OF THE INVENTION

The present invention provides an open cable broadcast processing apparatus which prevents a channel supplying software information from being changed while upgrading software of a cable card and stably completes the upgrading operation, and a control method thereof, and a cable card software upgrading method for an open cable system.

According to an aspect of the present invention, there is provided an open cable broadcast processing apparatus which comprises a tuner which tunes a cable signal supplied from a delivery system; an interface which is connected to a cable card which receives the cable signal from the tuner through the interface and descrambles the cable signal; and a controller which controls the tuner to change a reception channel based on channel information which is received from the cable card through the interface if the channel information instructs tuning to a channel which is broadcasting a software upgrade, wherein the controller prevents an operation corresponding to an operational change command if the operational change command is input to request an operational change.

According to another aspect of the present invention, the controller prevents the operation corresponding to an operational change command while the software upgrade is being received.

According to another aspect of the present invention, the software upgrade is received by the cable card and the cable card upgrades software with the software upgrade which is received.

According to another aspect of the present invention, the controller determines whether a completion signal is received from the cable card through the interface to indicate that receipt of the software upgrade is complete, and the controller allows the operation corresponding to the operational change command to be performed if the operational change command is input and it is determined that the completion signal is received.

According to another aspect of the present invention, an input unit which receives the operational change command as an input to request the operational change, and the controller prevents the operational change which is requested through the input unit if the channel information which instructs tuning to the channel which is broadcasting the software upgrade is received.

According to another aspect of the present invention, the input unit comprises a plurality of manipulation keys to input the operational change command and the plurality of manipulation keys comprises at least one of a channel change key to change the reception channel, a picture-in-picture (PIP) function key, a PIP channel change key, an electronic program guide (EPG) function key, a plurality of numeral keys, a navigation key and a video source change key.

According to another aspect of the present invention, the cable card and the interface support an interface of a Personal Computer Memory Card International Association (PCMCIA) standard.

According to another aspect of the present invention, there is provided a method of controlling an open cable broadcast processing apparatus which comprises a tuner which tunes a cable signal supplied from a delivery system and an interface which is connected to a cable card which receives the cable signal from the tuner through the interface and descrambles the cable signal, the method comprising determining whether channel information is received from the cable card through the interface which instructs tuning to a channel which is broadcasting a software upgrade; controlling the tuner to change a reception channel based on the channel information if it is determined that the channel information is received from the cable card; and preventing an operation corresponding to an operational change command if the operational change command is input to request an operational change.

According to another aspect of the present invention, the method further comprises determining whether a completion signal is received from the cable card through the interface to indicate that receipt of the software upgrade is complete; and allowing the operation corresponding to the operational change command to be performed if it is determined that the completion signal is received.

According to another aspect of the present invention, the cable card and the interface support an interface of a Personal Computer Memory Card International Association (PCMCIA) standard.

According to another aspect of the present invention, the method further comprises providing an input unit which receives the operational change command as an input to request the operational change.

According to another aspect of the present invention, there is provided a cable card software upgrading method for an open cable system which has an open cable broadcast processing apparatus and a cable card, the method comprising supplying channel information to the open cable broadcast processing apparatus from the cable card to instruct tuning to a channel which is broadcasting a software upgrade; changing a reception channel by the open cable broadcast processing apparatus based on the channel information which is supplied; upgrading the software by the cable card based on the software upgrade which is broadcast by the changed reception channel; and preventing an operation corresponding to an operational change command by the open cable broadcast processing apparatus if the operational change command is input to request the operational change.

According to another aspect of the present invention, the method further comprises supplying a completion signal to the open cable broadcast processing apparatus by the cable card to indicate that receipt of the software upgrade is complete; and allowing the operation corresponding to the operational change command to be performed if the completion signal is received by the open cable broadcast processing apparatus.

According to another aspect of the present invention, the cable card supports an interface of a Personal Computer Memory Card International Association (PCMCIA) standard, and communicates with the open cable broadcast processing apparatus.

### BRIEF DESCRIPTION OF THE DRAWINGS

The above and/or other aspects of the present invention will become apparent and more readily appreciated from the following description F of the exemplary embodiments, taken in conjunction with the accompanying drawings of which:

FIG. 1 is a control block diagram of an open cable system according to an exemplary embodiment of the present invention;

FIG. 2 is a control flowchart for upgrading software of a cable card for the open cable system according to an exemplary embodiment of the present invention; and

FIG. 3 is a control flowchart of an open cable broadcast processing apparatus in the open cable system according to an exemplary embodiment of the present invention.

### DETAILED DESCRIPTION OF THE EXEMPLARY EMBODIMENTS OF THE INVENTION

Reference will now be made in detail to exemplary embodiments of the present invention, examples of which are illustrated in the accompanying drawings, wherein like reference numerals refer to like elements throughout.

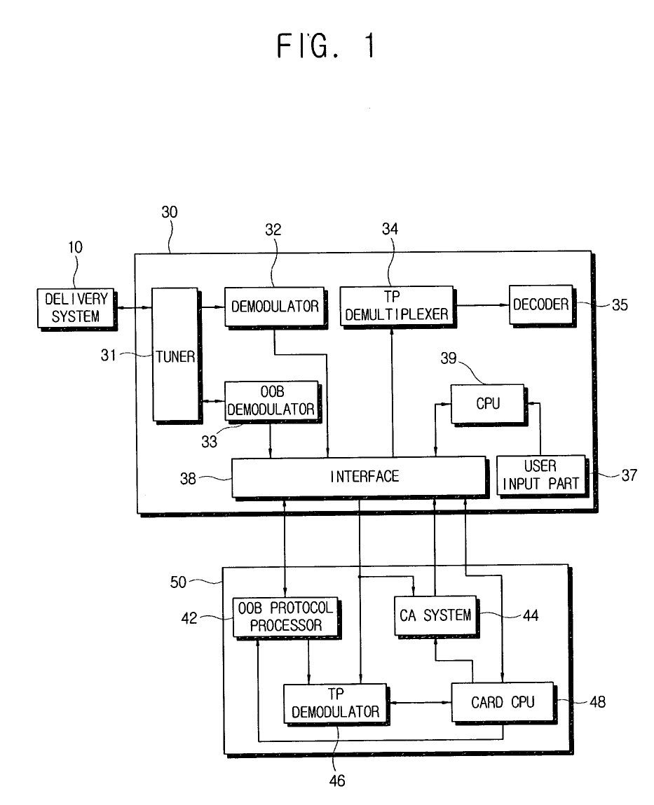

As shown in FIG. 1, an open cable system according to an exemplary embodiment of the present invention comprises a delivery system 10, an open cable broadcast processing apparatus 30 and a cable card 50.

The delivery system 10 comprises a head end which relays signals for a cable broadcasting. The delivery system 10 delivers a broadcasting signal for public broadcasting programs and a cable signal for cable broadcasting programs. The cable signal delivered by the delivery system 10 comprises a cable broadcasting program which is delivered by an IB, and OOB data which is delivered by an OOB. Here, the OOB data comprises data to control the delivery system 10 and the open cable broadcast processing apparatus 30, and additional information on a broadcasting program.

The delivery system 10 delivers an upgrading command signal at predetermined intervals or events to command a software upgrading operation of the cable card 50. Here, the delivery system 10 may deliver the upgrading command signal through one of the IB and the OOB. Also, the delivery system 10 may deliver software information through a preset channel to upgrade the software of the cable card 50.

The cable card 50 receives a cable signal which is output through a tuner 31 from a demodulator 32 and an OOB demodulator 33 (to be described later) of the open cable broadcast processing apparatus and descrambles it. The cable card 50 comprises a security module which is installed in the open cable broadcast processing apparatus 30 through an interface 38, and receives copy control information (CCI) defined by a contents provider and entitlement control message (ECM) information controlled by a service provider (i.e., a head-end system) thereby supporting a copy protection system (CPS) and a conditional access system (CAS).

The cable card 50 is an independent device which comprises a card CPU 48, instead having a module included in the open cable broadcast processing apparatus 30. The cable card 50 comprises an OOB protocol processor 42, a transport (TP) demultiplexer 46, a CA system 44 and the card CPU 48.

The OOB protocol processor 42 receives the OOB data which is demodulated by the OOB demodulator 33 (to be described later) of the open cable broadcast processing apparatus 30 and extracts OOB service information therefrom.

When the demodulator 32 (to be described later) of the open cable broadcast processing apparatus 30 transmits a scrambled cable broadcasting program signal which is quadrature amplitude modulation (QAM) demodulated, the CA system 32 descrambles the cable broadcasting program signal by a control of the card CPU 48 and outputs the descrambled broadcasting program signal to a TP. demultiplexer 34 (to be described later) of the open cable broadcast processing apparatus 30.

The TP demultiplexer 46 demultiplexes the QAM-demodulated cable broadcasting program signal transmitted from the demodulator 32 (to be described later) of the open cable broadcast processing apparatus 30 and the OOB service information extracted by the OOB protocol processor 42, and outputs them to the card CPU 48.

The card CPU 48 bi-directionally communicates with the delivery system 10 through the demodulator 32 (to be described later) of the open cable broadcast processing apparatus 30, and communicates with a CPU 39 (to be described later) of the open cable broadcast processing apparatus 30 through a data channel and an extension channel after interpreting a command from the delivery system 10.

The card CPU 48 upgrades the software of the cable card 50 by using a homing function in accordance with a command from the delivery system 10. That is, when the delivery system 10 transmits an upgrading command signal to upgrade the software of the cable card 50, the card CPU 48 outputs predetermined channel information to the CPU 39 (to be described later) of the open cable broadcast processing apparatus 30 to upgrade the software of the cable card 50. Then, the open cable broadcast processing apparatus 30 changes a reception channel to a channel designated by the channel information. The cable card 50 receives the software information from the changed reception channel, i.e., a preset channel supplying the software information to upgrade the software of the cable card 50. The card CPU 48 upgrades the software by using the supplied software information. When the software upgrading operation is completed, the card CPU 48 outputs a completion signal to the CPU 39 (to be described later) of the open cable broadcast processing apparatus 30 to indicate that the software upgrading operation is completed.

As shown in FIG. 1, the open cable broadcast processing apparatus 30 comprises the tuner 31, the demodulator 32, the OOB demodulator 33, the TP demultiplexer 34, a decoder 35, a user input part 37, the interface 38 and the CPU 39. According to an exemplary embodiment of the present invention, the open cable broadcast processing apparatus 30 may comprise a digital cable ready (DCR) TV or a DCR set top box.

The tuner 31 tunes a broadcasting signal or a cable signal of the channel controlled by the CPU 39, among a plurality of channels delivered by the delivery system 10. Here, the tuner 31 may comprise an inside channel tuner to receive a cable broadcasting program of the IB and an outside channel tuner to receive OOB data of the OOB, among frequency bands of the cable signal. Here, the OOB data may comprise various data including caption data, electronic program guide (EPG) data, service communication and authorization data.

The demodulator 32 demodulates audio and video signals of the cable broadcasting program of the channel tuned by the tuner 31. As most of the cable broadcasting programs of the tuned channel are modulated by a QAM method, the demodulator 32 may comprise a QAM demodulator which demodulates audio and video signals of the cable broadcasting program which are demodulated by a QAM method upon being received.

The OOB demodulator 33 demodulates the OOB data which is received by the tuner 33. As most of the OOB data is demodulated by a quadrature phase shift keying (QPSK) method, the OOB demodulator 33 may comprise a QPAK demodulator which demodulates the OOB data modulated by a QPAK method.

When the audio and video signals or the OOB data of the cable broadcasting program descrambled by the cable card 50 is input through the interface 38, the TP demultiplexer 34 demultiplexes the input signals into an audio signal, a video signal and OOB data.

The decoder 35 decodes the video signal input from the TP demultiplexer 34 and outputs it to an external device (not shown). Also, the decoder 35 decodes the audio signal input from the TP multiplexer 34 and outputs it to the external device (not shown). The decoder 35 decodes the OOB data input from the TP demultiplexer 34 and outputs it to the external device (not shown).

According to an exemplary embodiment of the present invention, the open cable broadcast processing apparatus 30 comprises the open cable set top box which includes the decoder 35 decoding the audio and video signals and the OOB data as a final output terminal to process the audio and video signals, but is not limited thereto. For example, the open cable broadcast processing apparatus 30 may comprise a multimedia processor (not shown) which processes the audio and video signals output from the decoder 35 to be displayed and output, and processes the signals to display the OOB data as caption when the OOB data output from the decoder 35 comprises the caption data. The open cable broadcast processing apparatus 30 according to an exemplary embodiment of the present invention may further comprise a display part (not shown) and a speaker (not shown).

The user input part 37 is provided to input an operational change command to change an operation. The user input part 37 may comprise a plurality of manipulation keys which are manipulated by a user. The user input part 37 may comprise various manipulation keys to request operational changes, such as a channel change key to change the reception channel received through the tuner 31; a PIP function key to execute a picture-in-picture (PIP) function; a PIP channel change key to change a channel displayed as a picture; an EPG function key to control an electronic program guide (EPG) function; a plurality of numeral keys; navigation up/down/left/right keys; and a video source change key to change a video source (e.g., a broadcasting signal, a cable signal, a video playing or a DVD playing signal).

The user input part 37 outputs a key signal corresponding to the key manipulated by a user, to the CPU 39. The user input part 37 may be provided on a front surface of the open cable broadcast processing apparatus 30, or as an additional input unit, i.e., a mouse (not shown), a keyboard (not shown) or a remote control.

The interface 38 is a communication unit which is connected with the cable 50, and supports an interface standard of a Personal Computer Memory Card International Association (PCMCIA).

The CPU 39 drives various prestored programs and controls the overall operations of the open cable broadcast processing apparatus 30 as a controller. Even though FIG. 1 does not illustrate a control line to control the tuner 31, the demodulator 32, the OOB demodulator 33, the TP demultiplexer 34 and the decoder 35 by the CPU 39, the CPU 39 controls the tuner 31, the demodulator 32, the OOB demodulator 33, the TP demultiplexer 34 and the decoder 35 to perform the overall operations of the open cable broadcast processing apparatus 30 and the operation of the present invention.

When the cable card 50 supplies the predetermined channel information through the interface 38 to upgrade the software thereof, the CPU 39 controls the tuner 31 to change the reception channel based on the supplied channel information. Thus, the cable card 50 receives the software information supplied from the delivery system 10 through the changed reception channel, and performs the software upgrading operation.

Here, the CPU 39 controls the tuner 31 to change the reception channel based on the supplied channel information and at the same time prevents the predetermined operational change command when the predetermined operational change command is input to request the operational change. That is, the CPU 39 does not change the operation corresponding to the input operational change command when the predetermined operational change command is input through the user input part 37 or through an internal input (e.g., entering an automatic power-saving mode) of the open cable broadcast processing apparatus 30 to request the operational change, after changing the reception channel to perform the upgrading operation of the cable card 50 to allow the software upgrading to complete.

The open cable broadcast processing apparatus 30 according to an exemplary embodiment of the present invention ignores the input operational change command and prevents the operation associated with the input command when the predetermined operational input command is input to change the channel supplying the software information while upgrading the software of the cable card 50 is being performed. Thus, the open cable broadcast processing apparatus 30 according to an exemplary embodiment of the present invention may prevent failure of the software upgrading operation of the cable card 50 even when an operation that would abruptly change the channel during the software upgrading operation of the cable card 50 occurs.

The CPU 39 determines whether the cable card 50 supplies a completion signal through the interface 38 to indicate that the software upgrading operation is completed. When the completion signal is received to indicate the completion of the software upgrading operation, the CPU 39 normally changes the operation corresponding to the input operational change command when the operational change command is input to request the operational change after receipt of the completion signal.

The open cable system according to an exemplary embodiment of the present invention ignores the input operational change command and does not perform the operation associated with the input when the predetermined operational input command is input to change the channel supplying the software information while upgrading the software of the cable card 50. Thus, the open cable system according to an exemplary embodiment of the present invention may prevent failure of the software upgrading operation of the cable card 50 even when an operation that would abruptly change the channel during the software upgrading operation of the cable card 50 occurs.

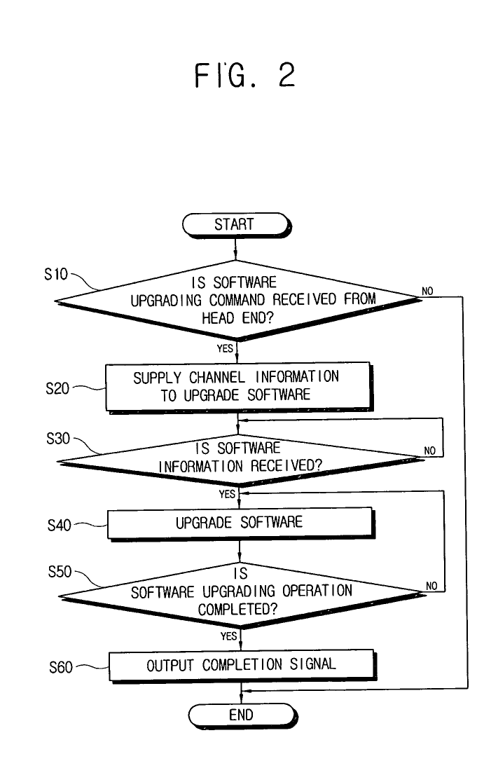

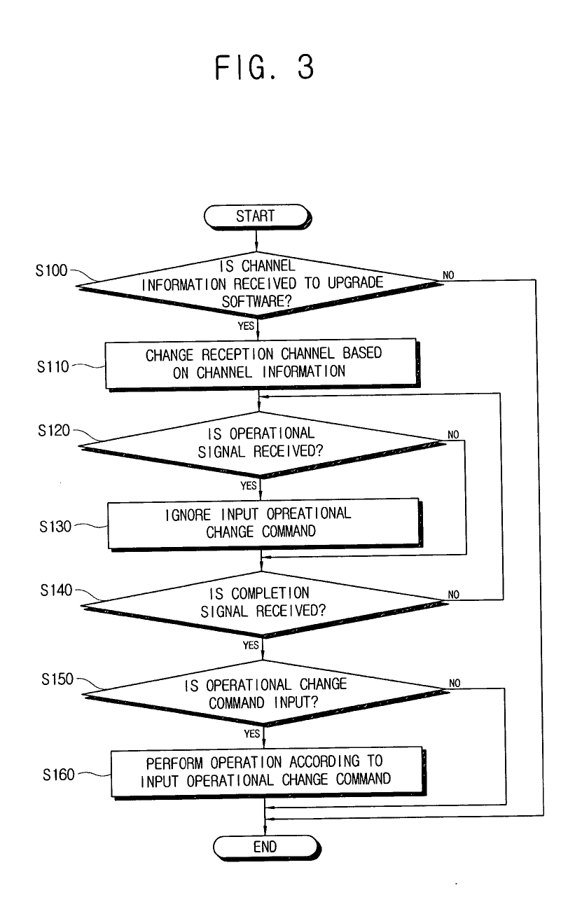

Hereinafter, a method of upgrading the software of the cable card for the open cable system according to an exemplary embodiment of the present invention will be described with reference to FIGS. 2 and 3. FIG. 2 illustrates a control flowchart for upgrading the software of the cable card 50, and FIG. 3 illustrates a control flowchart of the open cable broadcast processing apparatus 30.

First, the card CPU 48 of the cable card 50 determines whether the upgrading command signal is received from the delivery system 10 as the head end to perform the software upgrading operation by using the homing function (S 10). The card CPU 48 outputs the predetermined channel information to the CPU 39 of the open cable broadcast processing apparatus 30 to upgrade the software of the cable card 50 when the upgrading command signal is received from the delivery system 10 (S20). Then, the card CPU 48 determines whether the software information is supplied to upgrade the software through the reception channel changed by the channel information in the open cable broadcast processing apparatus 30 (S30). When the software information is supplied to upgrade the software, the card CPU 48 upgrades the software by using the supplied software information (S40). Then, the card CPU 48 determines whether the software upgrading operation is completed (S50), and outputs the completion signal to the CPU 39 of the open cable broadcast processing apparatus 30 to indicate that the software upgrading operation is completed (S60).

Meanwhile, the CPU 39 executes various prestored programs to perform overall operations of the open cable broadcast processing apparatus 30, and determines whether the predetermined channel information is received from the cable card 50 through the interface 38 to upgrade the software (S100). When the predetermined channel information is received from the cable card 50 to upgrade the software, the CPU 39 controls the tuner 31 to change the reception channel based on the received channel information (S110). Thus, the cable card 50 receives the software information supplied from the delivery system 10 through the changed reception channel, and upgrades the software (S40 in FIG. 2).

After the operation S110 in which the CPU 39 controls the tuner 31 to change the reception channel based on the received channel information, the CPU 39 determines whether the predetermined operational change command is input to request the operational change (S120). When the operational change command is input, the CPU 39 ignores the input operational change command and does not change the operation corresponding to the operational change command (S130).

The CPU 39 determines whether the completion signal is received from the cable card 50 through the interface 38 to indicate that the software upgrading operation is completed (S140). When it is determined that the completion signal is received to indicate the completion of the software upgrading operation, the CPU 39 determines whether the predetermined operational change command is input to request the operational change after the receipt of the completion signal (S150). When the operational change command is input after receiving the completion signal, the CPU 39 normally changes the operation corresponding to the input operational change command (S160).

As described above, the cable card software upgrading method for the open cable system ignores the input operational change command and does not perform the concerned operation when the predetermined operational change command is input to change the channel supplying the software information while upgrading the software of the cable card 50. Thus, the open cable system according to an exemplary embodiment of the present invention may prevent the failure of the software upgrading operation of the cable card 50 even when an operation that would abruptly change the channel during the software upgrading operation of the cable card 50 occurs.

As described above, the exemplary embodiments of the present invention provides an open cable broadcast processing apparatus which prevents a channel supplying software information from being changed while upgrading software of a cable card and stably completes the software upgrading operation and a control method thereof, and a cable card software upgrading method for the open cable system.

Although a few exemplary embodiments of the present invention have been shown and described, it will be appreciated by those skilled in the art that changes may be made in these exemplary embodiments without departing from the principles and spirit of the invention, the scope of which is defined by the appended claims and their equivalents.

What is claimed is:

1. An open cable broadcast processing apparatus, comprising:
a tuner which tunes a cable signal supplied from a delivery system;
an interface which is connected to a cable card which receives the cable signal from the tuner through the interface and descrambles the cable signal and
a controller which controls the tuner to change a reception channel based on channel information which is received from the cable card through the interface if the channel information instructs tuning to a channel which is broadcasting a software upgrade,
wherein the controller prevents an operation corresponding to an operational change command if the operational change command is input to request an operational change.

2. The apparatus according to claim 1, wherein the controller prevents the operation corresponding to an operational change command while the software upgrade is being received.

3. The apparatus according to claim 2, wherein the software upgrade is received by the cable card and the cable card upgrades software with the software upgrade which is received.

4. The apparatus according to claim 1, wherein the controller determines whether a completion signal is received from the cable card through the interface to indicate that receipt of the software upgrade is complete, and the controller allows the operation corresponding to the operational change command to be performed if the operational change command is input and it is determined that the completion signal is received.

5. The apparatus according to claim 4, the apparatus further comprising:
an input unit which receives the operational change command as an input to request the operational change, and wherein
the controller prevents the operational change which is requested through the input unit if the channel information which instructs tuning to the channel which is broadcasting the software upgrade is received.

6. The apparatus according to claim 5, wherein the input unit comprises a plurality of manipulation keys to input the operational change command and the plurality of manipulation keys comprises at least one of a channel change key to change the reception channel, a picture-in-picture (PIP) function key, a PIP channel change key, an electronic program guide (EPG) function key, a plurality of numeral keys, a navigation key and a video source change key.

7. The apparatus according to claim 6, wherein the cable card and the interface support an interface of a Personal Computer Memory Card International Association (PCMCIA) standard.

8. A method of controlling an open cable broadcast processing apparatus which comprises a tuner which tunes a cable signal supplied from a delivery system and an interface which is connected to a cable card which receives the cable signal from the tuner through the interface and descrambles the cable signal, the method comprising:
determining whether channel information is received from the cable card through the interface which instructs tuning to a channel which is broadcasting a software upgrade;
controlling the tuner to change a reception channel based on the channel information if it is determined that the channel information is received from the cable card; and
preventing an operation corresponding to an operational change command if the operational change command is input to request an operational change.

9. The method according to claim 8, wherein the operation corresponding to the operational change command is prevented while the software upgrade is being received.

10. The method according to claim 9, wherein the software upgrade is received by the cable card and the cable card upgrades software with the software upgrade which is received.

11. The method according to claim 8, further comprising:
determining whether a completion signal is received from the cable card through the interface to indicate that receipt of the software upgrade is complete; and
allowing the operation corresponding to the operational change command to be performed if it is determined that the completion signal is received.

12. The method according to claim 11, wherein the cable card and the interface support an interface of a Personal Computer Memory Card International Association (PCMCIA) standard.

13. The method according to claim 12, further comprising providing an input unit which receives the operational change command as an input to request the operational change.

14. The method according to claim 13, wherein the input unit comprises a plurality of manipulation keys to input the operational change command.

15. A cable card software upgrading method for an open cable system which has an open cable broadcast processing apparatus and a cable card, the method comprising:
supplying channel information to the open cable broadcast processing apparatus from the cable card to instruct tuning to a channel which is broadcasting a software upgrade;
changing a reception channel by the open cable broadcast processing apparatus based on the channel information which is supplied;
upgrading the software by the cable card based on the software upgrade which is broadcast by the changed reception channel; and
preventing an operation corresponding to an operational change command by the open cable broadcast processing apparatus if the operational change command is input to request the operational change.

16. The method according to claim 15, wherein the operation corresponding to the operational change command is prevented while the software upgrade is being received.

17. The method according to claim 16, wherein the software upgrade is received by the cable card and the cable card upgrades software with the software upgrade which is received.

18. The method according to claim 15, the method further comprising:
supplying a completion signal to the open cable broadcast processing apparatus by the cable card to indicate that receipt of the software upgrade is complete; and
allowing the operation corresponding to the operational change command to be performed if the completion signal is received by the open cable broadcast processing apparatus.

19. The method according to claim 18, wherein the cable card supports an interface of a Personal Computer Memory Card International Association (PCMCIA) standard, and communicates with the open cable broadcast processing apparatus.
